(19) United States
(12) Patent Application Publication
(10) Pub. No.: US 2005/0030928 A1
(43) Pub. Date: Feb. 10, 2005

(54) Provision of a data transmission connection

(75) Inventors: Kati Virtanen, Tampere (FI); Jussi Virtanen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/880,359

(22) Filed: Jun. 29, 2004

(30) Foreign Application Priority Data
Jun. 30, 2003 (FI) 20035117

(51) Int. Cl. H04Q 7/00; H04L 12/28; H04Q 7/24

(52) U.S. Cl. 370/338; 370/328; 370/351

(57) ABSTRACT

A method for transmitting status data via a short-range data transmission connection between at least two electronic devices. The method comprises forming a notification of at least one type of the status data in the first electronic device, forming a status message of the status data of the first electronic device in the first electronic device, and transmitting the status message via the short-range data transmission connection to the second electronic device.

### CROSS-REFERENCE TO RELATED APPLICATIONS

This application claims priority under 35 USC §119 to Finnish Patent Application No. 20035117 filed on Jun. 30, 2003.

### FIELD OF THE INVENTION

The present invention relates to a method and an apparatus for implementing the method, as well as a program for transmitting status data of a wireless communication device from the communication device to a user, in which method a short-range data transmission connection is provided between said wireless communication device and a terminal, and in which method at least one type of a notification of said status data for the user is formed in the wireless communication device.

In addition to a conventional speech connection, the option of a data connection has been developed for mobile communication systems, such as the GSM mobile communication system. The GSM mobile communication system is provided with a so-called fax modem service facilitating a modem connection to a data network via a mobile communication device used as a fax modem. A terminal using the fax modem, such as a laptop, is arranged in a data transmission connection with the mobile communication device by using, as the short-range connection, for example a cabled connection, such as a serial cable, or a wireless connection, such as an infrared connection or a Bluetooth™ connection. Bluetooth is a trademark of Bluetooth SIG, Inc. After the installation of the short-range connection and the required modem drivers, the user can set up a data transmission connection from the terminal to a data network, for example the Internet, via the mobile station and the mobile communication network. In a system of said kind, the user is not bound to conventional cabled modem arrangements of a public switched telephone network or local area networks (LAN), and a modem connection can be set up anywhere within the coverage area of the mobile communication network.

### BACKGROUND OF THE INVENTION

The radio connection of a mobile communication device used as a fax modem to the mobile communication network may be based on any implemented network technology. In addition to a conventional circuit switched connection, the option of a packet switched connection has been developed for mobile communication systems, such as the GSM mobile communication system. To implement this packet-switched connection, the GSM mobile communication system is provided with a so-called General Packet Radio Service (GPRS). The GPRS makes it possible to use e.g. the Internet Protocol (IP) as well as the X.25 communication protocol, to transmit short messages (SMS, Short Message Service), to transmit e-mail, as well as to use WAP applications (Wireless Application Protocol). Such a packet data transmission connection provides a communication method which is more efficient than the circuit switched connection, particularly for asynchronic data transmission, because to use the packet switched connection, the resources of the mobile communication system are not allocated for the whole connection time but only for the time needed for the transmission of each packet. In the circuit switched connection, however, the connection is allocated for the whole time when it is active. By means of the packet switched connection, the user of a wireless communication device can, for example, keep an e-mail application activated all the time, wherein the user will notice an incoming e-mail message at once without reserving the mobile communication device for this purpose only. Because the packet switched connection only allocates resources according to the need, it may also be less expensive for the user as to the call costs when compared with a situation of using a circuit switched connection. This is the situation particularly when there is little data to be transmitted and received but a lot of time is taken to utilize it, as is often the case when reading e-mail messages.

A wireless connection, and particularly a short-range radio connection, such as Bluetooth, between the mobile communication device and the terminal involves a new problem in the arrangement of the present invention. Thanks to the Bluetooth, the mobile communication device does not necessarily have to be in the direct vicinity of the terminal to set up a connection between the terminal and the mobile communication device, as is typically the case when a short serial cable or an infrared connection is used. A serial cable is typically so short that, in practice, the mobile communication device must be placed on the same worktop as the terminal, and the functioning of an infrared connection, in turn, requires a line of sight between the devices. However, the Bluetooth has a significantly longer range, and the mobile communication device used as a fax modem does not even have to be in the same room during a working connection. This results in the problem that due to the distance between the devices, the user does not necessarily notice the changes in the different status data of the mobile communication device which may affect the functioning of the connection as such. Such status data may include, for example, the battery charge level and warning tones due to low charge, display and audio data indicating incoming calls, display and audio data indicating incoming text and multimedia messages, calendar or clock alarms, or any other alarms indicating the status of the mobile communication device, or a change therein.

The Bluetooth operates in the frequency range of 2.4 GHz, and the service range of the Bluetooth with normal output is presently some tens of meters. An application field of the Bluetooth technology is to replace cables and the need for a visual contact in the data transmission between devices, such as, for example, mobile communication devices, portable computers, cameras, and earpieces. The Bluetooth arrangement is also applied in applications of home automation with limited visual contact.

In the transmission technology based on the Bluetooth, frequency hopping is used on the ISM (Industrial, Scientific and Medical) frequency band, which ranges from 2.4000 to 2.4835 GHz. The number of channels in use at intervals of 1 MHz totals 79. Each channel is divided into time slots, and because of the frequency hopping, the device may change from one channel to another during a connection. The hopping frequency is, in the normal communication mode, 1600 hops per second, and the frequency hopping sequence is different in each piconet. A TDD (Time Division Duplex) connection means that packets are transmitted alternately by the parties of the data transmission connection. There can be 16 different packet types to be transmitted over the Bluetooth interface; the content data can be of two types: synchronic or asynchronic. Devices communicating under the same master constitute a unit which is known as a piconet. A device initiating communication first forms an identified connection in which it is allocated an identification code of three bits. This means that there can be 8 devices in a single piconet, one acting as a master and the others as slaves. The first device in the piconet is the master; the slaves will synchronize their internal clocks and their frequency hopping with the master. Several piconets joined together constitute a scatternet. At the same time, the master may support three synchronic connections (suitable for real-time connections) at a rate of 64 kbps between the master and a slave. Asynchronic connections, in turn, use all the capacity that is left over from synchronic connections; when all the capacity is in use, the rate is 723.2 kbps in one direction and 57.6 kbps in the other direction, or symmetrically 433.9 kbps in both directions.

Data is transferred in packets over the piconet. A typical Bluetooth packet format comprises three elements: an access code, a header, and payload data. The access code and the header are typically of a fixed length. The lengths of the access code and the header are 72 bits and 54 bits, respectively. The length of payload data may vary from 0 to 2745 bits. Various packet types can be formed depending on the parts included in the packet. The packet may comprise the access code alone, both the access code and the header, or all the three parts, i.e. the access code, the header and the payload data.

In a situation in which the wireless communication device is used as a fax modem for a terminal, and the wireless communication device has an active data transmission connection for the fax modem connection, it may be possible that a change occurs in the status data of the wireless communication device, of which the user should be informed. In the arrangement of prior art, the user's wireless communication device communicates with the terminal via an infrared connection, wherein the wire-less communication device is in the direct vicinity of the terminal. If a warning tone of a change in the status data is generated in the wireless communication device, it is very likely that the user will hear it and know to take possible measures, such as to connect the wireless communication device to a charging device if the charge of the battery is down. If the wireless communication device has been switched to a mute mode, which in this context means that the sound alarms and warning tones of the wireless communication device have been turned off, it is still possible to display information about a change in the status data on the display of the wireless communication device. If the user sees the display of the wireless communication device when using the terminal, he/she will know to take the necessary steps, as described above.

In another arrangement of prior art, the user's wireless communication device communicates with the terminal via a cable connection. In this case, as well, the user is likely to hear possible warning tones of the wireless communication device and to know to take the necessary steps. Typically, the connecting cable between the wireless communication device and the terminal (for example, a serial cable complying with the RS-232 standard) has the length of about one meter only, wherein the wireless communication device is in the direct vicinity of the terminal. If sound alarms have been turned off, the user can see information induced by a change in the status data on the display of the wireless communication device, as described in the example above.

In a third arrangement of prior art, the user's wireless communication device communicates with the terminal via a short-range wireless radio connection, such as the Bluetooth. If the wireless communication device is in the direct vicinity of the terminal, the user is still likely to hear possible alarm tones of the wireless communication device and to know to take the necessary steps. If sound alarms have been turned off, the user can see information induced by a change in the status data on the display of the wireless communication device, as described in the example above. However, the Bluetooth does not require that the wireless communication device be in the direct vicinity of the terminal, but it may be several meters, even tens of meters away. Thus, the user does not necessarily hear sound alarms induced by changes in the status data of the wireless communication device, or see information about the change in the status data on the display of the wireless communication device either.

In arrangements of prior art, there may be a situation in which the user does not hear or see a warning caused by changes in the status data of the wire-less communication device, either in the form of a sound warning or displayed information. As a result, the user's data connection from the terminal to the data network via the fax modem of the wireless communication device may be suddenly disconnected, because the user has not noticed that the charge level of the battery was down. This situation is particularly inconvenient in a situation in which a connection is open to an important server, such as, for example, a bank server. In arrangements of prior art, the user may also remain uninformed of possible incoming calls, text messages, multimedia messages, faxes, calendar alarms or other corresponding changes in the status data.

### SUMMARY OF THE INVENTION

Now, an improvement in the prior art has been invented to improve the transmission of status data of electronic devices and the communication between electronic devices involved in the data transmission. By the arrangement now invented, the usability of two electronic devices is improved in an environment in which the first electronic device is a wireless communication device and the second electronic device is a terminal, and in which environment a data transmission connection is set up from the terminal via the wireless communication device to a wireless communication network. The data transmission connection consists of a first subconnection between the terminal and the wireless communication device, and a second subconnection between the wireless communication device and the communication network. By the arrangement now invented, the user is informed of the status data of the wireless communication device used as the first electronic device, via the terminal used as the second electronic device. When the data transmission connection is active, information about the status data of the wireless communication device is transmitted from the wireless communication device via the first subconnection so that the user will know to take the necessary measures.

The arrangement now invented can be applied between any at least two electronic devices. The first and second electronic devices can be, in the above-described manner, a wireless communication device and a terminal, respectively, and these two devices communicate with each other via a short-range data transmission connection. The electronic devices used can also be, for example, two wireless communication devices or two terminals communicating with each other via a short-range data transmission connection. It is also possible that the electronic device used is any electronic device whose status data can be transmitted to another electronic device. Said electronic device may thus be, for example, a peripheral device, such as a printer, a scanner, a table set, a head set, or the like.

The arrangement of the invention is also suitable for a situation, in which the electronic devices, such as a wireless communication device and a terminal, communicate with each other in a short range, and data synchronization is going on between the devices, such as the synchronization of, for example, calendar data, contact data or the file system. By the arrangement of the invention, status data can be transmitted in the middle of said data transmission connection.

According to a first aspect of the invention, a method has been implemented to transmit status data of a first electronic device via a short-range data transmission connection between at least between a first and a second electronic device, in which method a notification of at least one type is formed of said status data of the first electronic device in the first electronic device. In the method, a status message is formed of said status data of the first electronic device in the first electronic device, and said status message is transferred via the short-range data transmission connection to the second electronic device.

According to a second aspect of the invention, an electronic device has been implemented, which comprises means for determining status data of a first electronic device, means for setting up a short-range data transmission connection to a second electronic device, and means for generating a notification of at least one type. Said electronic device also comprises means for generating a status message of the electronic device and means for transferring said status message via the short-range data transmission connection to the second electronic device.

According to a third aspect of the invention, a communication system has been implemented, which comprises at least a first and a second electronic device, and means for determining status data, means for setting up a short-range data transmission connection between the first and the second electronic device, and means for generating a notification of at least one type. Said communication system also comprises means for generating a status message of the first electronic device and means for transferring said status message of the first electronic device via the short-range data transmission connection from the first electronic device to the second electronic device.

According to a fourth aspect of the invention, a computer software product has been implemented, which comprises machine-executable program commands for determining the status data of the first electronic device, for setting up a short-range data transmission connection between the first and second electronic devices, for generating a notification of at least one type in the first electronic device. Said computer software product also comprises program commands for generating a status message of the first electronic device and for transferring said status message of the first electronic device via the short-range data transmission connection from the first electronic device to the second electronic device.

Considerable advantages are achieved by the present invention. When applying the method of the invention, it is possible to avoid disconnections of the data transmission connection particularly in situations in which the warning tones and warning texts informing about a change in the status data of the electronic device used as the wireless communication device, for example about the extinguishment of the charge of the battery, do not reach the user. By the method of the invention, the user is also better informed of possible calls, multimedia and text messages coming in via the wireless communication device, particularly in situations in which the warning tones and warning texts of the wireless communication device, informing about the status data of the wireless communication device, do not reach the user. By the method according to the invention, the user can also be better informed of changes in the status data of the electronic device which is essential for the user, for example from another electronic device communicating with the user's electronic device via a short-range data transmission connection.

### BRIEF DESCRIPTION OF THE DRAWINGS

In the following, the invention will be described in more detail with reference to the appended drawings, in which

FIG. 1 shows a mobile communication system, in which the invention can be applied,

FIG. 2 illustrates the method according to prior art in a reduced signalling chart,

FIG. 3 shows the method according to an embodiment of the invention in a situation of an incoming call, in a reduced signalling chart,

FIG. 4 shows a status message transferred between a wireless communication device and a terminal according to one embodiment of the invention, and

FIG. 5 shows, in a reduced block chart, a terminal and a wireless communication device according to an embodiment of the invention.

### DETAILED DESCRIPTION OF THE INVENTION

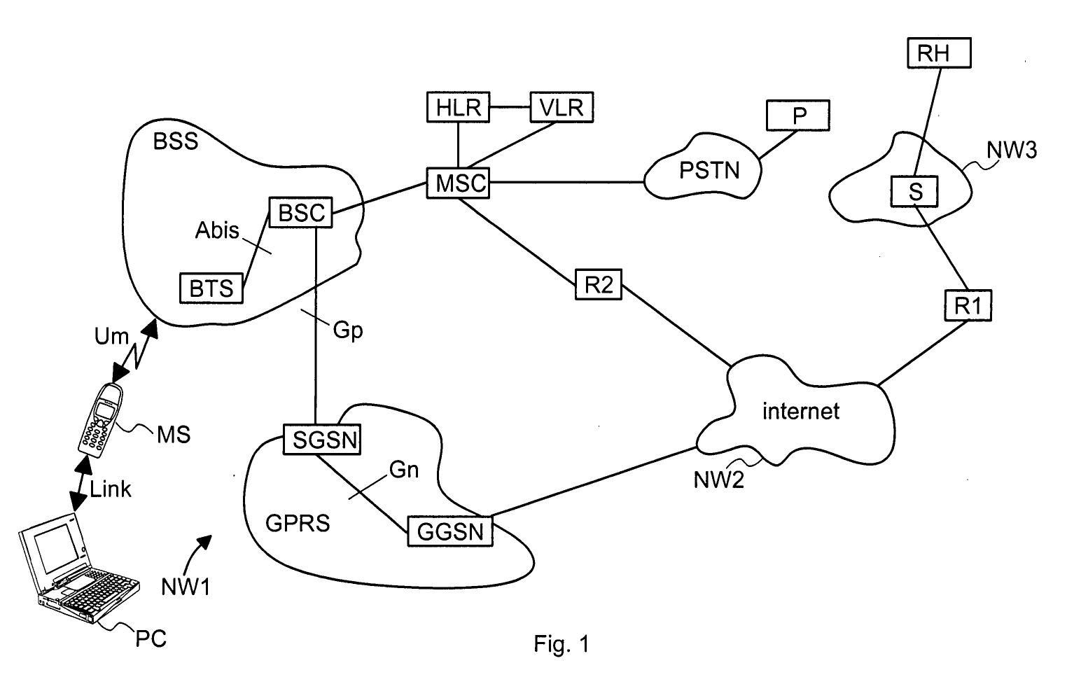

With reference to FIG. 1, a mobile communication system NW1, in which the invention can be applied, is shown in a reduced block chart. This mobile communication system NW1 comprises the facilities of the GSM mobile communication system and the GPRS system, but it will be obvious that the invention can also be applied in other mobile communication systems in which either a packet connection or circuit-switched connection is available. A wireless communication device MS is connected to a base station subsystem BSS via a radio interface Um, and a terminal PC is connected to the wireless communication device MS via a short-range connection. An example of this is shown in a reduced manner in FIG. 1. In FIG. 1, the data transmission connection is illustrated with an arrow marked with the reference LINK. In practical applications, this data transmission connection may be a cabled connection or a wireless connection, such as an infrared connection or a radio connection. The cabled connection may be, for example, a serial cable between the devices. The wireless connection may be, for example, IrDA technology (Infrared Data Association). The IrDA is based on infrared technology, wherein there must be a visual contact between the parties, and the distance is limited. Other possible short-range wireless communication technologies include, for example, Bluetooth™, WLAN (IEEE 802.11 standard), BRAN (HiperLAN 1/2), and HomeRF™. Bluetooth is a trademark of Bluetooth SIG, Inc. HomeRF is a trademark of HomeRF Working Group, Inc.

Yet another example of such a wireless terminal MS is a portable computer to which is coupled a card-like wireless communication device, such as a GSM mobile communication device. The wireless terminal MS comprises means for setting up both a circuit-switched connection (CS) and a packet-switched connection to a mobile communication network NW1.

FIG. 1 shows the blocks which are essential for the operation of the mobile communication system NW1. A serving GPRS support node SGSN controls the operation of the packet data transmission service on the side of the cellular network. The serving GPRS support node SGSN is responsible for the logging in and out of the wireless communication device MS, the updating of the position of the wireless communication device MS, and the routing of the data packets to the correct addresses. The wireless communication device MS is connected to the base station subsystem BSS via the radio interface Um. The base station subsystem is connected to the serving GPRS support node SGSN via a BSS-SGSN interface Gp. In the base station subsystem BSS, a base transceiver station BTS and a base station controller BSC are connected to each other via a BTS-BSC interface Abis. The serving GPRS support nodes SGSN can communicate with each other via gateway GPRS support nodes GGSN.

The wireless communication devices MS communicate with the base transceiver stations BTS via the air interface (radio interface) Um. The base transceiver stations are controlled by the base station controllers BSC which communicate with a mobile switching centre MSC. The base station controller BSC and the connected base transceiver stations BTS are also called a base station subsystem (BSS). The interface used in a circuit-switched connection between the mobile switching centre MSC and the base station subsystem BSS is called interface A. In a corresponding manner, the interface between the base station controller and the base transceiver station BTS is called interface Abis. The mobile switching centre MSC takes care of e.g. the control of incoming and outgoing calls in the same way as the switching centre of a public switched telephone network (PSTN; not shown). Moreover, the mobile switching centre MSC takes care of the operations required in mobile phone traffic, such as the control of the location of the mobile communication device e.g. by means of a home location register HLR and a visitor location register VLR. The mobile switching centre MSC can also be used to set up a circuit-switched connection to e.g. the Internet data network NW2 via one or more routers R2. Via the router R1, it is also possible to connect a local area network NW3 and further a server S connected to it, to the Internet data network NW2, in a way known as such. Also, a work station RH can be connected to the local area network NW3.

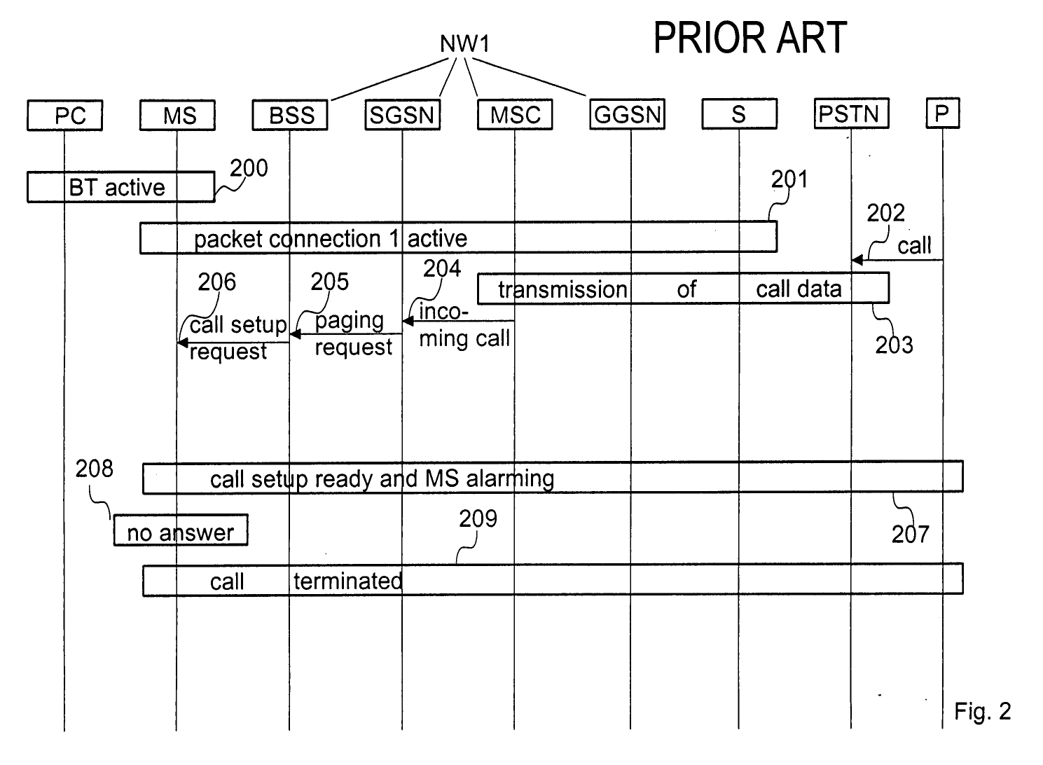

With reference to FIG. 2, in the method according to prior art, the user activates the Bluetooth link in the wireless communication device MS, for which certain connection settings have been typically predetermined in a terminal PC for the use of the fax modem. After the activation of the Bluetooth link, the Bluetooth signal transmitted by the wireless communication device is detected and recognized by the terminal. Such automatic recognition of the Bluetooth signal is known as such in terminals, particularly portable computers, and it accelerates the setting up of the Bluetooth link, because the link does not need to be separately activated by the user. If necessary, the user must arrange the wireless communication device MS and the terminal PC in a pair so that after this, the devices can be recognized in a reliable way and data transmission is safe between the devices. Naturally, instead of automatic recognition, the Bluetooth link can also be separately activated from the terminal before the data transmission connection is set up. The activation of the Bluetooth link between the terminal and the wireless communication device is illustrated in block 200. Depending on the terminal and the operating system, the actual way of setting up the data transmission connection may vary, but typically, the terminal has a separate network connection application to be used by the user to determine the initializations of the modem connection which in this case comprise, for example, defining the connection type between the Bluetooth wireless communication device and the terminal, and a connection number to be used as the modem connection number supported by the mobile communication network, in the case of the GPRS service for example the number “*99#”. When started, the above-described network connection application starts to communicate over the Bluetooth link with the wireless communication device used as a modem. The data transmission connection is set up from the terminal via the wireless communication device to the mobile communication network by sending a paging request to the wireless communication device. The wireless communication device activates a PDP context (Packet Data Protocol) to the GPRS network and sets up a connection via the gateway GPRS support node GGSN to the Internet data network. After this, the wireless communication device sends the terminal a confirmation about the setting up of the connection, after which the applications in the terminal can use the established connection for data transmission. The setting up of the connection is prior art known as such, and its description in more detail is not necessary in this context.

Now, a packet-switched connection has been activated in the wireless communication device, wherein information can be transmitted in data packets between the mobile communication system NW1 and the wireless terminal MS in a way known as such. This is shown in block 201 in the signalling chart of FIG. 1, in which data is transmitted via a gateway GPRS support node GGSN routing across the packet-switched connection between the wireless communication device MS and the server S. When a call is coming in the wireless communication device MS from e.g. a telephone P of a public switched telephone network PSTN (arrow 202), the telephone network PSTN transmits information about the call to the mobile switching centre MSC of the mobile communication network NW1 in a way known as such (block 203). The mobile switching centre MSC transmits a message about the incoming call to the serving GPRS support node SGSN, which is illustrated by arrow 204 in FIG. 1. The serving GPRS support node SGSN transmits a paging request of a circuit-switched connection to the base station subsystem BSS to which the wireless communication device MS is connected at the time (arrow 205). For determining the position of the wireless communication device at the time, if necessary, a home location register HLR and/or a visitor location register are used, which is prior art known as such. From the base transceiver station BTS, the base station subsystem BSS transmits the paging request of a circuit-switched connection further to the wireless communication device MS (arrow 206), in which the message is received and interpreted. The wireless communication device MS detects that a circuit-switched call is coming in, wherein the packet-switched connection is interrupted but not disconnected for the time of the circuit-switched call. For the time of the circuit-switched call, the active PDP context is set by the wireless communication device in an inactive state as defined for a GPRS terminal of category B (not shown in the figure). In the case of a GPRS terminal of category A, the wireless communication device is capable of setting up a circuit-switched call by also keeping the packet-switched connection active at the same time. After the paging request (arrow 206), the wireless communication device and the network set up a circuit-switched call (block 207) before the actual circuit-switched call connection. At the time of setting up the circuit-switched call (block 207), the wireless communication device typically alarms the user with a ringing tone or another corresponding alarm, for example by a vibration alarm. If the user does not hear the ringing tone or take any notice of another alarm indicating an incoming call in the wireless communication device, the user does not know about the incoming call and thus cannot answer it (block 208), wherein the call connection is disconnected (block 209).

Other situations similar to an incoming circuit-switched call, in which a corresponding problem occurs in systems of prior art, have been described earlier in this application. Such situations may include, for example, the extinction of the charge in the battery of the mobile station and the neglected alarming tone, a calendar alarm, the tone of an incoming text message, the tone of an incoming text message, the tone of an incoming multimedia message, or the like.

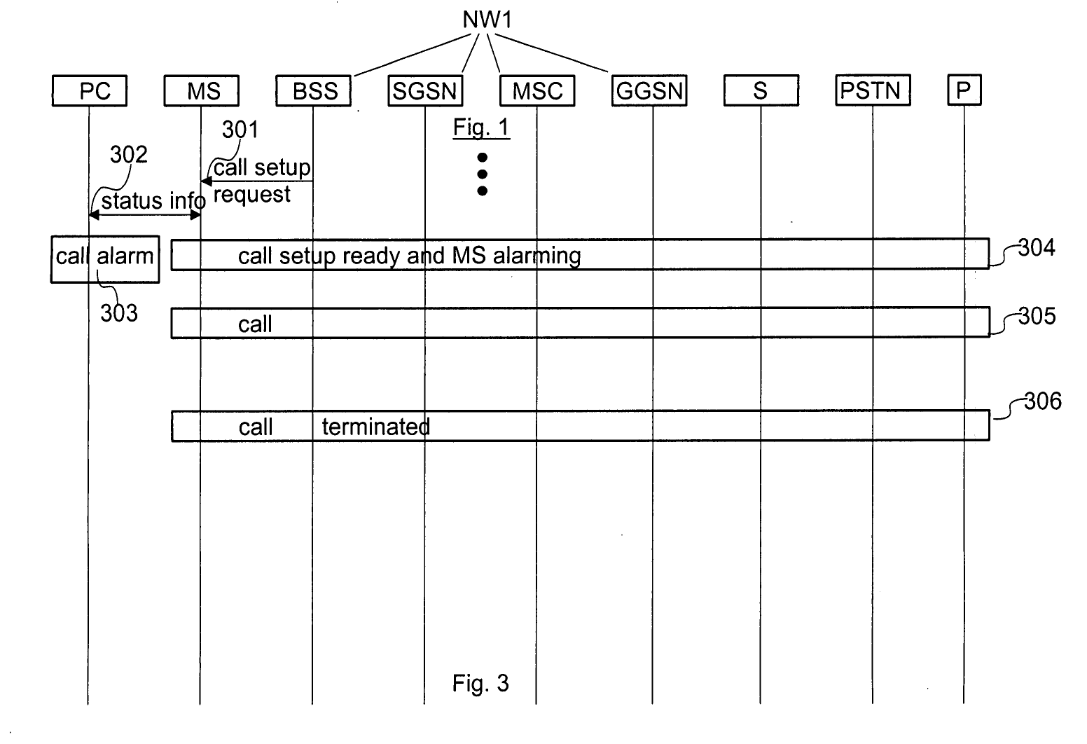

With reference to FIG. 3, in the method according to one embodiment of the invention, the packet-switched connection is set up by using the Bluetooth link between the devices as described above up to the point where the base station subsystem BSS sends the paging request of the circuit-switched connection from the base transceiver station BTS further to the wireless communication device MS (arrow 301). According to the invention, after this, the wireless communication device MS transmits a status message of the circuit-switched call over the Bluetooth link to the terminal PC (arrow 302) at the same time when the wireless communication device MS alarms the user with a ringing tone (block 304). However, the user may have switched the alarms of the wireless communication device to a mute mode, or the wireless communication device is, for any reason, so far from the user that the user does not hear the alarms of the wireless communication device. In this case, after receiving the status message, the terminal PC can inform the user via the interface of the PC, for example via the display and/or the speakers (block 303). On the basis of the information obtained via the PC, the user knows to answer the incoming call even though he/she were unaware of the alarms of the wireless communication device MS. After the call (block 305), the call is disconnected in a way known as such (block 306).

Furthermore, in addition to an incoming circuit-switched call, other corresponding situations in which the present invention overcomes problems of prior art have been described earlier in this application. Such situations may include, for example, the extinction of the charge in the battery of the mobile station and the neglected alarming tone, a calendar alarm, the tone of an incoming text message, the tone of an incoming text message, the tone of an incoming multimedia message, or the like.

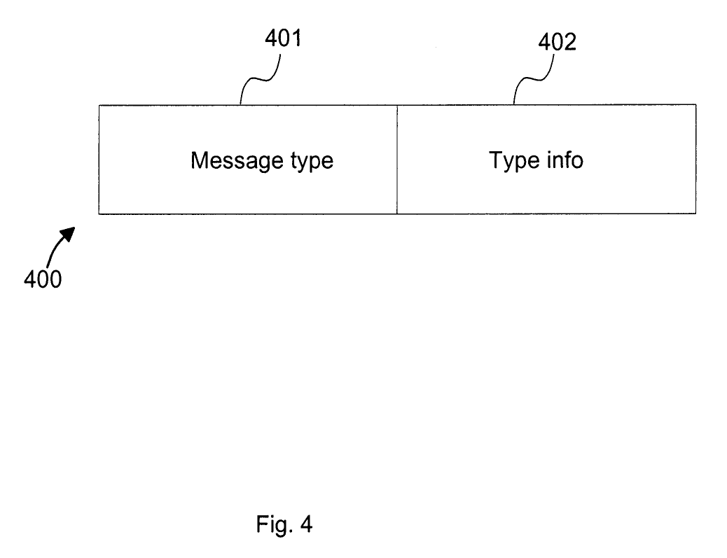

According to a possible implementation of the invention, the status message received by the terminal PC from the wireless communication device MS (arrow 302) is a status message transmitted across the Bluetooth link, comprising information about a change in the status of the wireless communication device MS. FIG. 4 illustrates a possible content of a status message 400. This status message comprises, for example, a message type field 401 and type info field 402, of which the message type field 401 defines the change of status data that the message relates to, and the type info field 402 defines auxiliary definitions about the change, as such, for the type of the status data. An example of a possible status message is given below:

If the message type field 401 is, for example, given by using three bits, the definitions could be the following:

| Message type value: | Definition: |
|---|---|
| 000 | battery empty |
| 001 | incoming/waiting call |
| 010 | incoming short message |
| 011 | incoming multimedia message |
| 100 | calendar alarm |
| 101 | clock alarm |
| 110 | other Bluetooth device requesting connection |
| 111 | Vacant |

The type info field 402 may be a character-based field of a fixed length to include auxiliary data relating to the type of the status data. Possible definitions for the type info field 402 include, for example:
remaining battery capacity as percentage or absolute value,
identification data of an incoming call, number/name,
identification data of the sender of a text message and possibly the text message as such,

If the electronic device informing about the status data is, for example, a printer, it is possible to use the value ‘111’ for the message type field 401 and to use the type info field 402 for a more detailed description of the status data in question. In this case, possible definitions for the type info field 402 include, for example:
no paper in the printer,
no ink in the printer,
fault situation in the device.

Also in other respects, the value ‘111’ of the type field 401 is suitable for the transmission of general information about the status of the electronic device, when the more detailed definition of the status is given in the type info field 402.

If the message type field 401 is, for example, given by using a bit map of eight bits, the definitions could be the following:

| Message type value: | Definition: |
|---|---|
| 00000001 | battery empty |
| 00000010 | incoming/waiting call |
| 00000100 | incoming short message |
| 00001000 | incoming multimedia message |
| 00010000 | calendar alarm |
| 00100000 | clock alarm |
| 01000000 | other Bluetooth device requesting connection |
| 10000000 | Vacant |

The bitmap solution of the above-described kind can be used for informing about several items of status data in a single status message 400. For example, the value ‘00000101’ of the message type field 401 would convey information about the charge level of the battery and an incoming text message. The bit size of the message type field 401 is fully variable according to the application environment.

According to a possible implementation of the invention, the definitions of the message type field 401 and the type info field 402 in the status message can be negotiated between the electronic devices. The definitions of the status message 400 are set by the first electronic device and then transmitted to the second electronic device. Also, the single definitions in the status message can be changed between the electronic devices, if necessary. The definitions can also be changed without transmitting the changes between the devices. In such a case, for example the user must change the definitions in the second device.

According to a possible embodiment of the invention, the status message 302, 400 is generated in the first electronic device as a response to a request by the second electronic device. In this embodiment, the status message 302, 400 can be used both for requesting and responding to the status message.

According to a possible embodiment of the invention, the terminal PC displays, as a result of a status message received from the wireless communication device MS, information about the status of the wireless communication device on the display of the terminal PC, for example in a separate window or as an application icon of the wireless communication device. In addition to the display, information can also be transmitted to the user via the speakers, indicator lights (LED, light emitting diode) and/or vibration alarm of the terminal PC. In said information window or icon, the user can also be given the option of inquiring the wireless communication device about the status data. In this embodiment, the user can, at any time, use the terminal to inquire the wireless communication device about the above-mentioned status types of the concurrent status data. The information window of the monitoring application can also be well visible and available for the user during the whole active time of the application, or alternatively, the window can only be introduced, for example, when the status of the wireless communication device is changed.

According to a possible embodiment of the invention, the terminal PC presents, as a result of a status message received from the wireless communication device MS, information from the monitoring application about a circuit-switched call coming in the wireless communication device, on the display of the terminal PC or by other means mentioned above. The user can thus also answer the incoming circuit-switched call via the monitoring application of the terminal PC, wherein the terminal PC is used as a user interface for the wireless communication device during the call. The microphone and the speaker of the terminal PC are used to replace the microphone and the speaker of the wireless communication device MS, and the audio information is transferred via a Bluetooth link or a corresponding short-range link from the terminal PC to the wireless communication device MS in a way known as such. Thus, the user does not need to pick up the wireless communication device MS to answer the call but may answer the call at the terminal PC.

It is obvious that the above-presented principles can also be applied in a situation in which the call is not answered. Similarly, the above-presented principles can also be applied in said other changes in the status data. According to one embodiment of the invention, the monitoring application displayed on the display of the terminal PC informs the user not only of the status change but also of possible other alternatives to respond to the status change. One possibility is to create, on the display means of the terminal PC, a modelled image of the user interface of the wireless communication device MS with its display and keypad, wherein the user can, by using the user interface of the terminal, control the operation of the wireless communication device MS in relation to said status change. Another possibility is that the monitoring application of the terminal PC does not model the user interface of the wireless communication device MS but presents the user the different function alternatives in an application window, where the user can select the desired function.

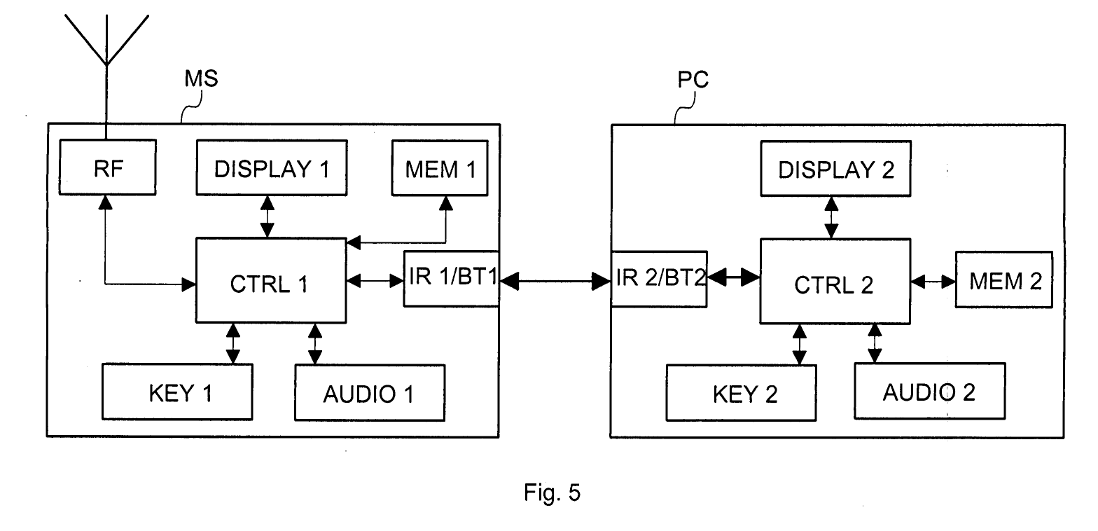

With reference to FIG. 5, two electronic devices are presented according to one embodiment of the invention, for example a wireless communication device MS and a terminal PC in a reduced block chart. In the figure, some functional blocks have been drawn which are necessary in view of explaining the invention. The wireless communication device MS has a processor block CTRL1 which can be implemented with one or more processors, such as a microprocessor, a digital signal processing unit, etc., in a way known as such. This processor block CTRL1 can also be formed as a part of a so-called application specific integrated circuit (ASIC) in which also other functions of the wireless communication device MS can be implemented. For data storage, the wireless communication device MS has a memory MEM1, such as a read-only memory, a random access memory, and/or a non-volatile random access memory. A radio part RF comprises the necessary means for implementing radio communication with the base transceiver station BTS. Furthermore, the wireless communication device MS comprises, for example, a keypad KEY1, a display DISPLAY1, audio means, such as a speaker and a microphone AUDIO1, as well as a short-range communication port IR1/BT1. The terminal PC has also a processor block CTRL2 which can be implemented with one or more processors, such as a microprocessor, a digital signal processing unit, etc., in a way known as such. This processor block CTRL2 can also be formed as a part of a so-called application specific integrated circuit (ASIC) in which also other functions of the terminal PC can be implemented. Also, the terminal PC has a memory MEM2, a keypad KEY2, a display DISPLAY2, audio means, such as a speaker and a microphone AUDIO2, and a short-range communication port IR2/BT2, for functions corresponding to those of the above-described blocks of the wireless communication device MS. By means of the short-range communication ports, the wireless communication device MS and the terminal PC are arranged to communicate with each other. In practical applications, this data transmission connection can be any wireless connection, such as an infrared connection or a short-range radio connection, for example a Bluetooth connection. The wireless communication device MS comprises means for setting up both a circuit switched connection (CS) and a packet switched connection to a mobile communication network NW1. The invention can also be applied in a situation in which the short-range data transmission connection between the terminal PC and the wireless communication device MS is cabled, for example by a serial cable between said devices. Furthermore, the invention can be applied in a situation in which the electronic devices communicate with each other via a short-range data transmission connection but neither has a radio part RF for implementing radio data transmission to a base transceiver station BTS. Such a situation exists, for example, between an electronic device and its peripheral devices, such as a terminal and a printer. In a corresponding manner, the invention can also be applied between two terminals.

The present invention has several advantages over the arrangements of prior art. The invention can be applied, for example, between a mobile phone used as the wireless communication device MS in the direction of a telecommunication network, and other mobile phones, personal digital assistants, compact portable computers, hi-fi equipment, and the like, used as the terminal PC. In addition to a mobile phone, the wireless communication device MS can also be any other device or device combination having a radio connection to a telecommunication network, such as a portable computer with a radio card for the connection to the telecommunication network.

In this context, the implementation and embodiments of the invention have been presented by means of examples. It will be obvious for a person skilled in the art that the invention is not limited to the details of the above-presented embodiments and that the invention can also be implemented in other forms without deviating from the characteristics of the invention. Consequently, the presented embodiments should be considered as being illustrative but not restrictive. The possibilities to implement and use the invention are thus limited by the appended claims only. Thus, also various alternatives to implement the invention, as well as equivalent implementations, defined by the claims fall within the scope of the invention.

1. A method for transmitting status data of a first electronic device via a short-range data transmission connection between at least a first and a second electronic device, the method comprising:
forming a notification of at least one type of said status data of the first electronic device in the first electronic device,
forming a status message of said status data of the first electronic device in the first electronic device, and
transmitting said status message via the short-range data transmission connection to the second electronic device.

2. The method according to claim 1, comprising:
receiving the status message of the first electronic device in the second electronic device, and
forming as a response to the status message a notification of at least one type in the second electronic device.

3. The method according to claim 1, comprising forming the status message of the first electronic device as a response to a request by the second electronic device.

4. The method according to claim 1, comprising forming the status message of the first electronic device as a response to at least one of the following states of the first electronic device:
battery charge level down,
incoming/waiting call,
incoming text message,
incoming multimedia message,
calendar alarm,
clock alarm,
another device using a short-range data transmission connection is requesting connection,
no paper in the printer,
no ink in-the printer,
fault situation in the device.

5. The method according to the claim 1, comprising using a Bluetooth connection as the short-range data transmission connection.

6. The method according to the claim 1, comprising using one status message of the first electronic device to convey information about at least two different states.

7. The method according to the claim 1, comprising defining the status data contained in the status message of the first electronic device by the first electronic device.

8. The method according to claim 7, comprising transmitting the definitions of the status data included in the status message of the first electronic device to the second electronic device.

9. An electronic device comprising
means for defining status data of the electronic device;
means for setting up a short-range data transmission connection to another electronic device;
means for generating a notification of at least one type;
means for generating a status message of the electronic device; and
means for transmitting said status message via the short-range data transmission connection to the another electronic device.

10. The electronic device according to claim 9, comprising:
a receiver for receiving a status message of another electronic device; and means for forming as a response to the status message a notification of at least one type.

11. The electronic device according to claim 9, comprising a receiver for receiving a request of a status message from the another electronic device, wherein said means for generating a status message of the electronic device being adapted to form the status message of the electronic device as a response to said request.

12. The electronic device according to claim 9, wherein said means for generating a status message of the electronic device being adapted to form the status message of the electronic device as a response to at least one of the following states of the electronic device:
battery charge level down,
incoming/waiting call,
incoming text message,
incoming multimedia message,
calendar alarm,
clock alarm,
another device using a short-range data transmission connection is requesting connection,
no paper in the printer,
no ink in the printer,
fault situation in the device.

13. The electronic device according to claim 9, wherein said means for trans-mitting said status message comprise a Bluetooth transmitter.

14. The electronic device according to claim 9, wherein the means for generating a status message of the electronic device being adapted to use one status message to convey information about at least two different states.

15. A communication system comprising at least:
a first electronic device;
a second electronic device;
means for defining status data of the first electronic device;
means for setting up a short-range data transmission connection between the
first and the second electronic device;
means for generating a notification of at least one type;
means for generating a status message of the first electronic device; and
means for transmitting said status message of the first electronic device via
the short-range data transmission connection from the first electronic device
to the second electronic device.

16. A computer software product which comprises machine-executable program instructions for:
defining status data of a first electronic device;
setting up a short-range data transmission connection between the first electronic device and a second electronic device;
generating a notification of at least one type in the first electronic device;
generating a status message of the first electronic device; and
transferring said status message of the first electronic device via the short-range data transmission connection from the first electronic device to the second electronic device.

17. A wireless communication device comprising:
means for defining status data of the wireless communication device;
means for setting up a short-range data transmission connection to another device;
means for generating a notification of at least one type;
means for generating a status message of the wireless communication device; and
means for transmitting said status message via the short-range data transmission connection to the another device.
